(19) United States
(12) Patent Application Publication
(10) Pub. No.: US 2024/0378502 A1
(43) Pub. Date: Nov. 14, 2024

(54) METHOD FOR GENERATING COMPARISON PAIRS AND DISTRIBUTING THEM TO INDIVIDUAL COMPARISON REQUESTS FOR EXPERIMENT PARTICIPANTS

(71) Applicant: Robert Bosch GmbH, Stuttgart (DE)

(72) Inventors: Florian LANG, Ludwigsburg (DE); Andreas HENKE, Ditzingen (DE); Carine AU, Stuttgart (DE); Felix SCHORN, Renningen (DE); Michael KUKA, Waiblingen (DE); Thomas ALBER, Filderstadt (DE); Zoltan LEICHT, Budapest (HU)

(21) Appl. No.: 18/636,513

(22) Filed: Apr. 16, 2024

(30) Foreign Application Priority Data
May 8, 2023 (DE) 10 2023 204 216.9

(51) Int. Cl. G06N 20/00; G06N 5/022

(52) U.S. Cl. CPC G06N 20/00; G06N 5/022

(57) ABSTRACT

A method for generating comparison pairs and distributing them to individual comparison requests for experiment participants for subjective individual ratings of pair comparisons. The method includes: providing a data set comprising sensory samples; identifying potentially promising comparison samples for each sample based on a metric, wherein the metric is based on a relationship between a possible estimation of the rating by experiment participants and at least one quantitative characteristic of the sample; distributing a predetermined number of overall comparisons to the potentially promising comparison pairs; generating the comparison requests for experiment participants by assigning the comparison pairs to the comparison requests, taking into account the following conditions to the effect that each sample is not provided more frequently than once in a comparison request, each sample is equally often provided for predetermined subgroups of the entirety of all experiment participants.

### CROSS REFERENCE

The present application claims the benefit under 35 U.S.C. § 119 of German Patent Application No. DE 10 2023 204 216.9 filed on May 8, 2023, which is expressly incorporated herein by reference in its entirety.

### FIELD

The processing of sensory input variables by computer-aided models experiences ever-increasing use through the continuous development of artificial intelligence (AI) methods. Common applications in this respect relate to the processing of sensory impressions as also experienced by humans. This includes, for example, the classification of objects in camera images (for example in the context of highly automated driving), the classification of sounds in the context of safety systems (recognition of sirens, human screams, shots, etc.), or the processing of texts (i.e., the classification of the words in an image).

Most applications in this area are thus in the area of classification. For example, in the field of acoustics, there are hardly any AI models that are concerned with regressions (i.e., with the assignment of floating point numbers) on the basis of samples, such as sounds. One of the main reasons for this is that such models require a high number of input data for model training. In the case of classifications, these input data are still comparatively easy to acquire since many different samples can be generated from a single sample by slight modifications, without changing the class of the sample (the so-called label) in the process. For example, an image of a cat can be rotated somewhat, changed in contrast, mirrored or otherwise filtered; the motif still shows a cat so the label for the training does not change; and many different samples, which nevertheless provide useful information to the model, can be created from a single sample.

This is also true in the area of acoustic classification; slight modifications of the frequency sample or amplitude sample, the addition of noise, and similar modifications do not, for example, cause a siren to suddenly no longer be a siren. Here, too, the label consequently remains the same and modifications of the samples can generate a great many new samples for training data-intensive classification models, which new samples make the models more robust.

However, in the area of regressions, such modifications change the label. An example in this respect is a change in the dominant frequency of a siren, where the question “how pleasant is this sound on a scale of 1 to 10?” is to be answered by the model. It is obvious that any modification of the sample in this case also changes the label in an unpredictable manner. Consequently, models for predicting such regression questions would have to be trained on the basis of samples which were actually fully pre-rated by humans. Here, not only the number of necessary labeled samples for training large AI models but also the problem of the subjectivity of the individual responses (and thus the need to have each sample rated by many experiment participants in order to obtain an objective label) leads to such models hardly being found due to the extremely poor scalability of the data labeling.

The challenges in ascertaining an overall rating as objective as possible on the basis of subjective individual ratings have been known in this respect for a long time. This is not limited to only customer feedback on products but can also be a complex task when seeking expert opinions or when asking similar questions. Often times, the same questions arise: How many people need to be surveyed in order to obtain a statistically stable result? How should the survey be designed? Are the experiment participants, for example, to assign points on a defined response scale to the individual samples or should other types of surveys be used? In the field of acoustics in particular, the planning, conduct and evaluation of so-called auditory experiments is an area of intensive research for which many guidelines already exist. Often applied in such cases is the methodology of presenting the experiment participants with a scale (for example, school grades from 1 to 6 or a Rohrmann scale with different, verbally formulated response options), on which they are to classify the presented samples. Subsequently, mean value considerations or other considerations of the response distributions are performed in order to assign an overall rating to each sample. Alternatively, it is also possible to perform pair comparisons in which the experiment participants are to indicate the preference from 2 presented product sounds, for example. An overall rating for each individual product on the basis of many pair comparisons can subsequently, for example, be ascertained by probabilistic methods. However, since each comparison must also be rated here by many participants in order to obtain a stable result, and since a high number of comparison pairs results very quickly in the case of a mutual comparison of all existing samples (for example, 100 product sounds result in 100²=10000 combinations; omitting the comparisons of identical sounds (A vs A) reduces this number to 100²−100=9900; the reduction to only one comparison direction (i.e., only ever A vs. B, never B vs A) reduces the number to (100²−100)/2=4950), this methodology seems unsuitable in many cases. In addition, methods on the basis of pair comparisons achieve the highest result accuracy if each of the two response options has been selected at least once (i.e., if the probability that A was rated better than B is not 100% or 0%), which again increases the requirement for a high number of experiment participants.

Both in the case of subjective ratings on the basis of scales and with pair comparisons and other methods, the problem of having a sufficiently high number of experiment participants answer a question thus arises, wherein, if nothing else, the limit of human ability (for example, in terms of concentration and retentiveness when successively rating various samples) also constitutes an additional limitation for the number of test samples and also reduces the precision and thus the meaningfulness of the obtained results overall. The training and the technical application of extensive regression models on the basis of such data are therefore hardly found.

### SUMMARY

A first general aspect of the present invention relates to a method for generating comparison pairs and distributing them to individual comparison requests for experiment participants for subjective individual ratings of pair comparisons.

According to an example embodiment of the present invention, the method comprises providing a data set of sensory samples; identifying potentially promising comparison samples for each sample on the basis of a metric, wherein the metric is based on a relationship between a possible estimation of the rating by experiment participants and at least one quantitative characteristic of the sample; distributing a predetermined number of overall comparisons to the potentially promising comparison pairs, according to the following conditions: each sample is equally often provided in a pair comparison, each sample is equally often provided as a response option A and a response option B in the pair comparisons. The method furthermore comprises generating the comparison requests for experiment participants by assigning the comparison pairs to the comparison requests, taking into account the following conditions to the effect that each sample is not provided more frequently than once in a comparison request and that each sample is equally often provided for predetermined subgroups of the entirety of all experiment participants.

A second general aspect of the present invention relates to a method for objectively rating a sensory sample, comprising providing a sensory sample and rating the sample with a rating model.

A third general aspect of the present invention relates to a computer system designed to perform the method according to the first and/or the second general aspect (or an embodiment thereof).

A fourth general aspect of the present invention relates to a computer program designed to perform the method according to the first and/or the second general aspect (or an embodiment thereof).

A fifth general aspect of the present invention relates to a computer-readable medium or signal, which stores and/or contains the computer program according to the fourth general aspect (or an embodiment thereof).

The techniques of the first, second, third, fourth and fifth general aspects can have one or more of the following advantages in some situations.

The present invention results in an increased accuracy of the ascertained objectified ratings of samples through pair comparisons while significantly reducing the effort for their collection, which, for example, translates into considerably lower costs due to the optimized selection of the promising comparison pairs.

An advantage of the present invention in particular becomes evident when a high number of samples (for example, several hundred or several thousand) are to be rated. This can, for example, take place with the goal of subsequently obtaining a model formation, such as AI-based models for the future prediction of the rating of new samples, on the basis of the plurality of obtained ratings.

So far, such regression models could not be generated or could only be generated at considerable costs due to the immense data collection effort. However, according to the present disclosure, these data can be obtained efficiently and in high quality, and the models can consequently be generated and then used, for example, to optimize the driving of technical products.

Additionally, (assuming a sufficiently high number of overall ratings) the optimized distribution of the pair comparisons to defined subgroups of the entirety of all experiment participants subsequently also makes it possible to analyze rating differences between the individual subgroups so that even a user-specific driving of technical products on the basis of the user data or a targeted product development for a specific user group is possible.

The term “potentially promising” comparison pairs can, for example, be described by a BTL probability curve as shown in one of FIGS. 2 and 3. In this case, the unambiguous comparisons, i.e., “sample A is preferred to sample B in 100% or 0% of the comparisons performed,” accordingly lead to (theoretically) infinite distances between the samples A and B. Thus, these comparisons do not provide additional information to the mathematical model for calculating a numerical distance between the samples and are accordingly not considered as “potentially promising” comparison pairs.

### BRIEF DESCRIPTION OF THE DRAWINGS

FIG. 1 is a flowchart illustrating techniques of the present invention for generating comparison pairs and distributing them to individual comparison requests.

FIG. 2 shows a diagram of the relationship between the probability p(i>j) and the distance of the two BTL ratings 40 according to the present invention.

FIG. 3 shows a diagram for identifying the potential comparison partners according to the present invention.

FIG. 4 shows a further diagram for identifying the potential comparison partners according to the present invention.

FIG. 5 shows a diagram of the distribution of the comparisons to the sound pairs, as well as the distribution of the pair comparisons to the individual comparison requests k according to the present invention.

FIG. 6 schematically shows systems in which the techniques of the present invention can be used to generate comparison pairs and to distribute them to individual comparison requests.

### DETAILED DESCRIPTION OF EXAMPLE EMBODIMENTS

The method according to the present invention constitutes a procedure for efficiently ascertaining objectified overall ratings on the basis of subjective ratings of pair comparisons, which can achieve high result accuracy and can be efficiently performed even with a high number of comparison samples. On the basis of the obtained data, data-intensive AI models can subsequently be trained and installed on end devices in order there, for example in the acoustic context, to use a microphone signal to optimize the control of the end device with regard to the pleasantness of the operating sound. Obtaining the necessary data is achieved by an optimized selection of those comparison pairs that are identified as being particularly meaningful on the basis of a metric for estimating the expected overall rating, from the entirety of all possible comparison pairs.

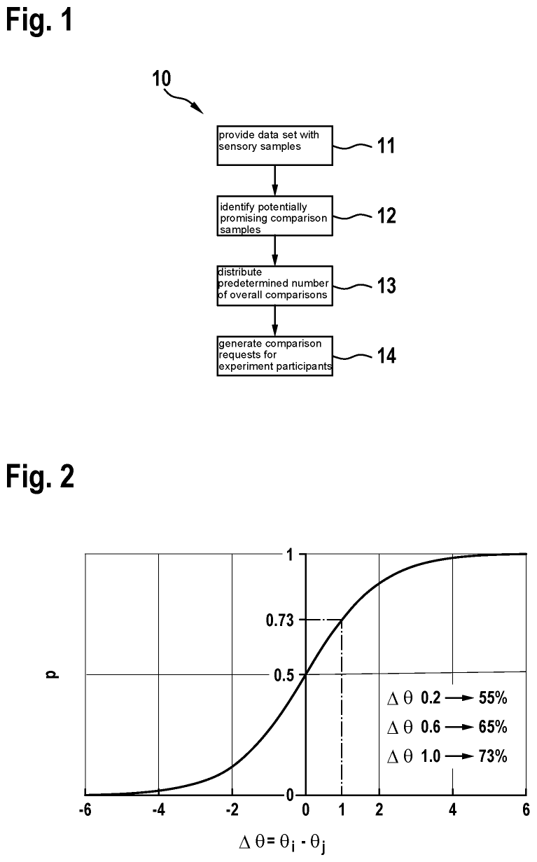

FIG. 1 shows a method 10 for generating comparison pairs and distributing them to individual comparison requests for experiment participants for subjective individual ratings of pair comparisons.

First, a data set with sensory samples is provided 11. The sensory samples can comprise humanly perceptible stimuli. These stimuli are, for example, sounds, images, texts, temperatures, odors. Everything that human sensory systems can perceive and rate is included. The sensory samples are generated by a sensor.

Subsequently, potentially promising comparison samples for each sample are identified 12 on the basis of a metric, wherein the metric is based on a relationship between a possible estimation of the rating by experiment participants and at least one quantitative characteristic of the sample. This metric allows for a rough estimation of the expected rating and thus reduces the computational effort. As a metric for identifying promising comparison pairs from the entirety of all possible comparison pairs, two simple variables can be used, for example: The samples are ordered either with respect to their psychosensory maximum perception or with respect to their mean amplitude.

If predicted BTL distances, i.e., distances in the objective rating space, are too large, the evaluation can be discontinued, which increases the efficiency. Instead of a discontinuation, the detected gaps can be filled with additional samples in order to avoid unambiguous comparisons in the subsequent experiment. The objective rating can, for example, be a numerical rating.

A predetermined number of overall comparisons is distributed 13 to the potentially promising comparison pairs, according to the following conditions:
each sample is equally often provided in a pair comparison,
each sample is equally often provided as a response option A and a response option B in the pair comparisons,

Furthermore, the comparison requests for experiment participants are generated 14 by assigning the comparison pairs to the comparison requests, taking into account the following conditions to the effect that
each sample is not provided more frequently than once in a comparison request,
each sample is equally often provided for predetermined subgroups of the entirety of all test participants.

The predefined subgroups can, for example, be so-called sociocultural groups and thus, for example, allow for an equally frequent rating of each sample by men and women. The affiliation with one or more of the subgroups and/or sociocultural groups can be checked by asking the experiment participants predefined questions. For example, through an introductory question (e.g., “Do you have a driver's license for a passenger car?”), the appropriate user for the survey can selectively be accepted for individual experiments. In which case, owning a driver's license cannot necessarily be considered as a sociocultural property.

In individual cases, slight deviations from the specified rules for the samples can result because the predefined entirety of all pair comparisons is generally not a multiple of the number of pair comparisons within the individual comparison requests for the experiment participants. The number of available samples as well as the desired number of sociocultural groups among the experiment participants also affect the mathematical feasibility of the mentioned criteria. Within the framework of the experiments conducted so far, these deviations were of the order of magnitude of rounding errors and were thus marginal for the result.

Another variant provides that a predetermined number of overall comparisons is distributed to the potentially promising comparison pairs, taking into account the further condition of interspersing a predetermined number of pair comparisons with obvious responses (so-called honeypot comparisons). By interspersing these pair comparisons with obvious responses, it is possible to identify and exclude from the rating those experiment participants who perform the experiment with insufficient attention.

Another variant provides ascertaining an objective rating for each of the involved samples by means of an evaluation of the entirety of individual performed pair comparisons of samples by a mathematical model. The mathematical model can be a probabilistic model such as a Bradley-Terry-Luce (BTL) model. For example, the BTL model receives a list of all comparisons made, including the information as to which of the two samples involved “won” the comparison in each case. This consequently results in the probabilities for each compared pair (e.g., “A vs. B was rated at 73% in favor of A”). These probabilities result in the BTL distances according to the mentioned equation.

Another variant provides that the rating of a sample results from the probability of the sample preferences from all pair comparisons in all comparison requests. A resulting overall rating for a sample that takes into account all pair comparisons performed can thus be achieved.

Another variant provides that, after ratings of the samples by experiment participants have been ascertained, the following is carried out:
creating a rating model for objectively rating a sensory sample, comprising:
defining the rating as the output variable,
annotating the samples with the respective rating of the sample that results from the probability of the sample preferences from all pair comparisons in all comparison requests, and
optimizing the rating model by training with the annotated samples.

A model on the basis of the samples and the expertise of the experiment participants is thus formed, which can then automatically rate a sample as if it were rated by a series of subjects. Optimizing the model can, for example, be adjusting or optimizing the weights of a neural network. Deep or machine learning approaches can also be used. The input variable for the model can then accordingly be one or more quantitative characteristics of the sample.

Accordingly, a method for objectively rating a sensory sample comprises providing a sensory sample and rating the sample with a rating model created as discussed above. Such a model can, for example, be an AI model. The input variable is a quantitative characteristic of the sample, such as a spectrum of the sample. The spectrum of a sound can then, for example, be provided as an input, and the output of the model can be a rating with a numerical value of, for example, 4.2.

This method for objectively rating a sensory sample can be separate and independent of the aforementioned method for generating comparison pairs and distributing them to individual comparison requests. Just as well, the two methods can be combined with one another.

The method for generating the comparison pairs and distributing them to the individual experiment participants can be considered the essential preparation step for conducting an experiment for ascertaining an objectified rating on the basis of subjective individual ratings, which are absolutely necessary for the training of data-intensive regression models. For example, in the application within the framework of auditory experiments, the algorithm ultimately generates a list of comparison requests, wherein each of these requests contains a defined number of pair comparisons (e.g., 100 pair comparisons, of which 93 pairs are actual product sound pairs and 7 comparisons are so-called honeypot comparisons). In addition, metadata, such as the sociocultural group affiliation of the desired experiment participant, are stored for each comparison request so that the comparison requests can be offered via an application on mobile end devices to users who correspond to the desired sociocultural profiles. This form of the distribution of the experiments to a large global group of participants makes it possible to conduct the auditory experiment quickly and cost-efficiently even with a high number of sound samples (and thus a high total number of pair comparisons).

A variant provides
obtaining the sensory sample from a test object,
generating a rating of the sample,
controlling at least one parameter of the test object that affects the sample, and
repeating the steps until the rating reaches a target value.

By means of this control loop or closed loop, operating states of the test object that are desired or pleasant for persons can be set by controlling at least one parameter of the test object or test device.

In principle, the described methodology can be applied whenever the objectified rating of samples (in particular in the case of a high number of samples) is to be ascertained through pair comparisons. The obtained data can then be used for model formation, and the resulting models can be used in the development or optimization of technical applications. For the optimized selection of the particularly promising comparison pairs for the collection of data, it is in this case true that a metric for roughly estimating the expected rating is available.

This metric can be designed to be as complex as desired. The described methodology has already been tested several times with great success when conducting auditory experiments. The sounds to be rated always originated from a technical product, such as a heat pump, an e-bike, a package delivery drone, or a dishwasher. The sounds may in this case comprise the full range of possible sounds of a product, i.e., for example, in the case of a heat pump, compressor-dominated sounds, fan sounds, ramp-up sounds, sounds under partial loads and full loads, etc. This makes it possible for the models subsequently trained on the basis of the obtained data, to predict the human perception of the sound in all relevant operating states.

Two simple variables were initially used as a metric for identifying promising comparison pairs from the entirety of all possible sound pairs: The sound samples were ordered either with respect to their psychoacoustic loudness or with respect to their mean sound pressure level. Subsequently, the algorithm for generating the pairs and the distribution to the comparison requests of the individual experiment participants ensured that each sound can only be paired with a defined number of neighboring sounds with respect to the selected metric in order to avoid unambiguous sound pairs for which all experiment participants are thus highly likely to give the same response. From the range of the possible comparison partners of each sound sample (e.g., the 10 neighboring sounds toward lower loudness/sound pressure levels and the 10 neighboring sounds toward higher loudness/sound pressure levels), the algorithm now formed and distributed the pairs so that the described requirements were optimally fulfilled.

In later auditory experiments, a non-linear relationship, ascertained on the basis of the results of the already performed auditory experiments, between loudness or sound pressure level and the expected overall rating was used as a metric for identifying the promising sound pairs. A pre-rating by a model, for example by an existing algorithm for rating sounds with regard to their expected rating by experiment participants, can also be used.

For identifying auditory experiment participants performing the experiment with insufficient attention, obvious sound pairs (so-called honeypots), which do not meet the mentioned criteria of the metric for pre-rating, were added in addition to the actual comparison pairs of product sounds. Here, for example, interspersing pair comparisons between the 10 loudest and the 10 quietest of all product sounds to be rated has been successfully tested. The underlying assumption is that users who diligently perform the auditory experiment and are not only interested in quickly “clicking through” in order to receive the financial payment for completing the experiment would always prefer a very quiet product over a very loud product. In individual cases in which this assumption may not be given at least for a relevant proportion of the entire user group (for example, in the rating of sports engine sounds), specifically selected “poor samples” (for example, the sounds of dentist drills) were also inserted in order to avoid ambiguities in the correlation between loudness and rating.

On the basis of the obtained data, data-intensive models (e.g., neural networks) which predict the pleasantness of the product sound could subsequently be trained. These models can then be applied to the technical product and be fed by a microphone signal, wherein the current pleasantness of the generated product sound is predicted on the basis of the microphone signal, and the optimization of driving the technical product, for example a heat pump, with regard to this variable, is performed in ongoing operation.

In the mentioned auditory experiments, the high number of pair comparisons was distributed globally via a crowdsourcing application for mobile end devices to users for rating, wherein a specified composition of the entirety of all experiment participants (for example with regard to their gender, their age, their continent of origin, their opinion on prespecified questions (e.g., “Do you like loud engine sounds?”) or similar sociocultural factors) was considered, where appropriate. The optimal distribution of the comparison requests to specified sociocultural groups subsequently also makes it possible for the model trained on the basis of the obtained data, to also predict the pleasantness of product sounds in a user-type-specific manner. Here, an e-bike or an automobile can be used as an example, in the case of which the current driver is notified to the product prior to starting a trip, for example via an app or a display installed on the product. Through targeted questions when creating such a user profile for the first time, both general sociocultural parameters (gender, age, etc.) and specific user preferences (“Do you prefer a sports driving experience?”) can already be known for each driver of the sample product. Thus, the current product sound can be predicted by the trained model on the basis of microphone signals for exactly this user group, which, within the framework of the auditory experiment, answered the posed questions similarly to the current driver and thus corresponds to the same user type.

The product sound can subsequently be optimized to correspond most closely to the likely preferences of the current user. The method can also be used within the framework of acoustic product development in that, for example, sounds from brake systems in a variety of operating states are prepared for an auditory experiment by the method and a prediction model is trained on the basis of the obtained data. Such an auditory experiment has already been successfully performed within the framework of the project. Now, the model can be used on a smartphone, which receives the current acoustic signal in good recording quality through a plug-in USB microphone, to predict the human perception of the current brake sound. This allows an immediate objective evaluation of brake sounds during test drives.

Since such an objective rating has so far been possible only through extensive recording of the sounds and subsequent rating within the framework of auditory experiments, developers have so far frequently only been able to draw on the subjective opinion of the test driver in this respect. Use of the method is also possible beyond the area of acoustic ratings. For example, the rating of various product designs is conceivable. The rating of various designs of electrical tools, the appearance of which is to be rated with respect to their effectiveness in order to use the subjective ratings to identify a product design that is as appealing and powerful as possible, can serve as a product example. In this case, the samples available for selection could, for example, be ordered in terms of the device size, and the algorithm could only allow pair comparisons with a defined number of neighboring samples in terms of the device size, similarly to what takes place in the area of the auditory experiments.

These data can then also be used to train a model that makes possible an immediate prediction of the likely customer perception of the design during product development. It is also conceivable for the method to be applied in further areas of visual subjective ratings, such as the rating of the emotional mood of a human facial expression for obtaining data for further machine learning applications. Here, the subjective rating of a human facial expression (e.g., “Which of the two persons shown seems more cheerful?”) can be used as an example. In this case, the promising comparison pairs can, for example, be identified in that all images to be rated are previously ordered with respect to the distance between both mouth corners and/or the strength of the visibility of teeth and/or the raising of the mouth corners above or below the mouth center. Such data can subsequently be used to train a model that evaluates the current facial expression in a live application (for example, a smartphone camera in selfie mode). Such applications are also conceivable within the framework of safety systems.

As already described, the entirety of many individual pair comparisons can be evaluated by probabilistic models in order to ascertain a numerical rating for each of the samples involved. A popular model is the so-called Bradley-Terry-Luce model (BTL model), which ascertains so-called BTL ratings Θi for each sample i involved. The underlying assumption is that, on the basis of the probability p(i>j), which describes the proportion of experiment participants who have preferred the sample i over the sample j in the pair comparisons, a distance ΔΘ=Θi−Θj exists between the BTL ratings of the two samples according to the following equation:

$$p ( i > j ) = \frac{1}{1 + {e}^{- ΔΘ}}$$

The relationship between the probability p(i>j) and the distance of the two BTL ratings ΔΘ is outlined in FIG. 2.

It becomes clear from this representation that, in the event of complete agreement of the opinion of all experiment participants (i.e., if 100% or 0% of all experiment participants prefer sample i over sample j), the theoretical distance between these two samples on the BTL scale would take on an infinite value. Numerical implementations of such probabilistic methods actually always generate finite BTL distances, which can, however, take on large values. Consequently, such unambiguous comparison results with p(i>j)=100% or p(i>j)=0% are at the expense of the result accuracy and additionally constitute an unnecessary cost factor since these comparisons were performed without being able to provide the BTL model with an information gain.

The present disclosure inter alia aims at optimizing the selection of the comparison pairs and the distribution of the comparisons to the experiment participants with the goal of a subsequent evaluation via a probabilistic method such as the described BTL model. As a result, the data required for the training of large regression models can be efficiently collected, and the models based thereon can subsequently be used to optimize technical products. By developing a metric for optimized identification of the samples that are expected to create a similar subjective impression and reducing the possible comparison pairs to only this comparison space, the probability of the occurrence of unambiguous comparison pairs with p(i>j)=100% or p(i>j)=0% during the experiment is significantly reduced.

As described, in the case of auditory experiments, the loudness of the samples, which is the most relevant variable for the subjective perception of the product sound for almost all products, can, for example, be used to pre-sort the sound samples in order subsequently to allow comparisons of a sample with only a certain number of neighboring sounds with respect to their loudness. Alternatively, however, it is also possible to establish a more complex relationship between variables, describing the sound, and their expected BTL distances (and thus implicitly the probabilities p(i>j)). In principle, the metric can thus be designed as complex as desired. In any case, however, it must provide an estimation for the later BTL distances on the basis of already known variables. The subsequent distribution of the ascertained sound pairs to the individual requests for the experiment participants is carried out by the described algorithm.

A metric that provides an estimation for the expected distances in the target variable can be derived as follows. In the case of auditory experiments, this can, for example, be the loudness of the sound samples, or even better still an equation for estimating the expected BTL distances between the individual samples, which estimation can be calculated on the basis of values such as loudness, sound pressure level, or the like. A pre-trained AI model on the basis of previous auditory experiments can also be used here. This model can, for example, also use a more complex input, such as spectral representations of the sounds, to pre-rate the BTL distances. The algorithm can also already warn the user at this point if the data set of the user has gaps that are too large with respect to the predicted BTL distances between the sound samples, since the risk of unambiguous comparison responses (p(i>j)=100% or p(i>j)=0%) increases at these points.

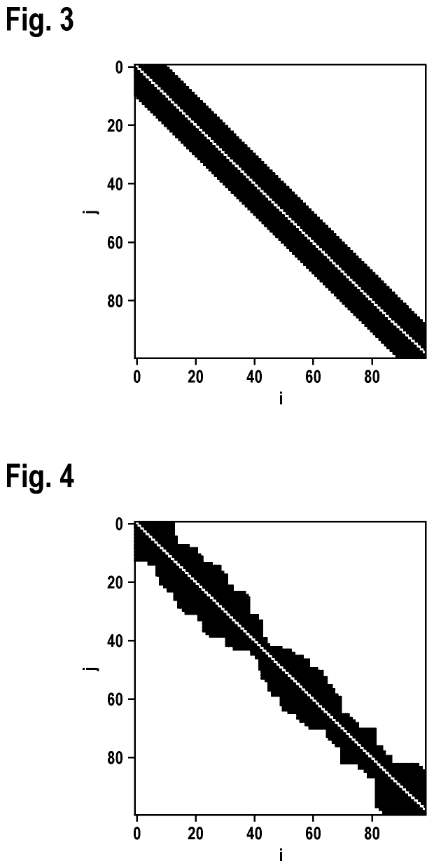

The potential comparison neighbors for each sound sample can be identified on the basis of the derived metric as follows. According to a first option shown in FIG. 3, the use of a fixed number of neighbors of each (sound) sample is provided, which are then available as potential comparison partners. In FIG. 2, a sample index i of a sample is plotted along the x axis and a sample index j of a further sample is plotted along the y axis.

In the case of auditory experiments, the 10 next louder and the 10 next quieter sound samples from the entire data set to be rated can, for example, be used as potential comparison partners for each sample. This is shown, by way of example, for a case of 100 sound samples in FIG. 3, where the value 1 (black coloring) means that the given comparison pairing can be used as a potential pairing, wherein the sounds are pre-ordered according to their BTL ratings estimated on the basis of the loudness.

According to a second option shown in FIG. 4, the use of a variable number of neighbors of each (sound) sample is provided, which number is, for example, identified by the number of neighbors within a certain distance with respect to the metric. In FIG. 3, a sample index i of a sample is plotted along the x axis and a sample index j of a further sample is plotted along the y axis.

In the case of auditory experiments, the equation for estimating the BTL distances of all samples can, for example, be used to identify, for each sample, the other sound samples that are within a certain BTL distance from said sample. The threshold to be used can be defined by the user of the algorithm. For example, comparisons can thus be allowed only within a BTL distance of ±0.7.

In order to prevent this criterion from having the result that, in particular, no restriction to only very few or even only a single neighboring sample occurs at the two extrema of the data set with respect to their expected BTL rating, it is also possible to implement a logic that searches for the potential comparison partners within the specified BTL distance threshold but uses at least a number of neighbors that is likewise to be specified (according to the logic “take all neighbors within a BTL range of ±0.7 but at least 5 on both sides if available”). In an extreme case, not a single neighboring sample occurs; for example, there is no neighbor within a defined BTL distance (such as +/−0.7). Here, too, it is possible to implement a logic that can either abort the algorithm, introduce new samples, or, for example, extend the BTL distance.

This is shown, by way of example, for a case of 100 sound samples in FIG. 4, in which the value 1 (black coloring) means that the given comparison pairing can be used as a potential pairing, wherein the sounds were pre-ordered according to their estimated BTL ratings.

All comparison pairs and the comparison requests can be generated as follows. Pairs that are actually to be rated in the subjective rating are now ascertained from the set of the potential comparison pairs. The number of overall pairs can, for example, be defined by a fixed value which is predetermined by the user of the algorithm and describes the set of the pairs to be generated by the algorithm per sample. An example in this respect is a situation in which the user of the algorithm specified a value of 100 pairs per sound sample for an auditory experiment, wherein a total of 800 sound samples is available in the data set.

For each sample, the algorithm now generates 100 pair comparisons with neighbors within the set of identified potential comparison partners of the relevant sample. This results in an entire set of pair comparisons within the data set of 100*800=80,000 comparisons. With regard to the terminology, it should be noted that, as a result of always two samples appearing in the 80,000 pair comparisons, a total of 160,000 sounds occurs; that is to say, on average, each sound occurs not 100× but 200× in a pair comparison.

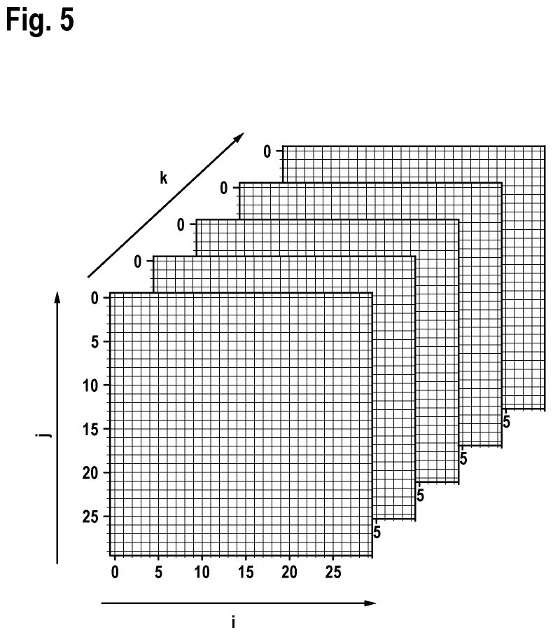

The distribution of the comparisons to the individual sounds i or sound pairs i, j, by the algorithm is carried out, like the distribution of all pair comparisons to the individual comparison requests k of the individual experiment participants, in consideration of the mentioned boundary conditions. This can be illustrated as follows: All experiment participants receive a request with a certain number of pair comparisons (of which, in turn, a small subset contains so-called honeypot comparisons for identifying negligent experiment participants). The distribution problem can thus be understood as a three-dimensional tensor in which the 3 dimensions are the appearance of the sound samples i and j (in the case of a total of N samples) and the affiliation with a particular comparison request k (in the case of a total of M comparison requests). In a very simple case of only 30 sound samples and 5 comparison requests, this can, for example, be illustrated according to FIG. 5.

The number of samples can actually be considerably higher and can be several hundred or several thousand samples. First, the comparisons to be distributed overall must now be defined. These comparisons depend on the desired accuracy of the final objectified rating, the number of samples to be rated, the number of comparisons per comparison request, and the number of honeypot comparisons per comparison request. In an example with 800 samples, in which 100 pair comparisons with neighbors are to be created per sample, wherein a single comparison request of an experiment participant is l^{Comparison} o contain 100 comparisons, of which 7 are in turn honeypot comparisons, a total number of pair comparisons results as follows:

$$800 Samples * 100 \frac{Comparisons}{Samples} = 8 \; 0000 Comparisons$$

The resulting number of comparison requests is calculated (by rounding up since no fractions of requests are allowed) as follows:

$$⌈ \frac{80000 Product comparisons}{93 \frac{Product comparisons}{Comparison request}} ⌉ = ⌈ 860.2 Comparison request ⌉ = 861 Comparison request$$

The task of the algorithm now consists in distributing the available set of overall comparisons to the existing empty tensor entries such that the mentioned boundary conditions are fulfilled. In particular, this means that
only integer entries greater than or equal to zero must occur
all comparison requests k in total contain a prespecified number of product comparisons (e.g., 93 comparisons), to which a prespecified number of honeypot comparisons (e.g., 7) is subsequently also added, i.e., that the sum of all “real” entries of a comparison request k must in this exemplary case result in 93. That is to say, for N sounds, the number of pair comparisons

$${\sum }_{i = 1}^{N} {\sum }_{j = 1}^{N} {n}_{i , j} = 93 for all K comparison requests$$

only comparisons within the potential comparison partners defined on the basis of the metric take place (with the exception of the honeypot comparisons)
each sample equally often occurs in a comparison, i.e., that the sum of the column sums i and the row sums j across all K comparison requests is ideally the same for each sample
each sample equally often occurs as a response option A and a response option B in a pair comparison, i.e., that, for each sample, the sum of the column sums i for each sample across all K comparison requests is ideally equal to the sum of the column sums j across all K comparison requests
each sample ideally occurs not more frequently than 1× per comparison request, i.e., that the sum of the column sums i and the row sums j for each of the N sound samples in a single comparison request k is not greater than 1
the samples are distributed to the comparison requests such that the comparison requests can be released to the experiment participants in a manner in which each sound sample is ideally rated with the same frequency by each sociocultural group from a number of L prespecified sociocultural groups. The pair comparisons contained in the individual comparison requests for the individual experiment participants are generally always composed differently due to the high number of comparison pairs to be distributed, i.e., there are no identical comparison requests between different participants. The solution of the formulated problem can be achieved very efficiently with regard to the complexity and the scope of the algorithm by using a numerical solver, taking into account the mentioned boundary conditions.

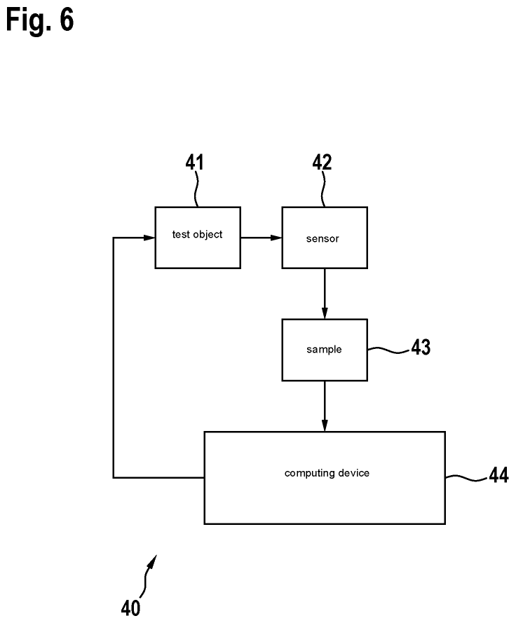

FIG. 6 schematically shows an exemplary implementation in software and/or hardware of the present disclosure.

A system 40, such as a computer system, is designed to objectively rate a sensory sample.

A test object 41 can be part of the system 40 or can be formed externally to the system 40. For example, the test object 41 is a technical system such as a heat pump or the like. A sensor 42 senses a variable of the test object 41, such as a temperature or a sound. The sensor 42 then outputs a sample 43, such as a spectrum or an amplitude curve.

A computing device 44 receives the sample 43 at an input. The computing device 44 can comprise a processor and/or a working memory, as well as a (non-volatile) memory. The computing device furthermore comprises the above-described rating model for objectively rating a sensory sample 43. The sensor 42 can be part of the computing device 44. The (computer) system 40 can correspond to the computing device 44.

Processing the measured value to form a sample 43, for example, can be provided in the sensor 42 and/or in the computing device 44.

The computing device 44 is designed to apply the rating model to the received sample 43 and to determine a rating of the sample 43, for example a sensory rating.

This rating can now, for example, be output optically on an output device for outputting the rating of the sample 43. The output device can be part of the computing device 44 or be external thereto.

Just as well, in the sense of a feedback or a control loop, the computing device 44 can control at least one parameter or one component of the test object 41 that affects the sample 43 or the corresponding variable of the test object 41. The then changed sample 43 is rated again by the computing device 44. This control or optimization is performed until a target value and/or an optimum is reached.

Furthermore disclosed is a computer program, which is designed to perform the (computer-implemented) method 10 for generating comparison pairs and distributing them to individual comparison requests and/or the (computer-implemented) method for objectively rating a sensory sample. The computer program may, for example, be present in interpretable or compiled form. For execution, it may be loaded (also in portions), for example as a bit or byte sequence, into the RAM of a computer.

Furthermore disclosed is a computer-readable medium or signal, which stores and/or contains the computer program. The medium may, for example, comprise one of RAM, ROM, EPROM, HDD, SDD, . . . on/in which the signal is stored.

What is claimed is:

1. A method for generating comparison pairs and distributing them to individual comparison requests for experiment participants for subjective individual ratings of pair comparisons, comprising the following steps:
providing a data set including sensory samples;
identifying potentially promising comparison samples for each sample based on a metric, wherein the metric is based on a relationship between a possible estimation of a rating by experiment participants and at least one quantitative characteristic of the sample;
distributing a predetermined number of overall comparisons to the potentially promising comparison pairs, according to the following conditions:
each sample is equally often provided in a pair comparison, and
each sample is equally often provided as a response option A and a response option B in the pair comparisons;
generating the comparison requests for experiment participants by assigning the comparison pairs to the comparison requests, taking into account the following conditions to the effect that:
each sample is not provided more frequently than once in a comparison request, and
each sample is equally often provided for predetermined subgroups of the entirety of all experiment participants.

2. The method according to claim 1, wherein the sensory samples include humanly perceptible stimuli.

3. The method according to claim 1, wherein: (i) the subgroups are sociocultural groups, and/or (ii) the affiliation with one or more of the subgroups is checked by predefined questions to the experiment participants.

4. The method according to claim 1, wherein the distribution of a predetermined number of overall comparisons to the potentially promising comparison pairs is carried out taking into account a further condition of interspersing a predetermined number of pair comparisons with an obvious response.

5. The method according to claim 4, wherein the comparison requests in which one or more of the pair comparisons with an obvious response are answered incorrectly are excluded from the further processing.

6. The method according to claim 1, further comprising:
after the comparison requests have been performed:
ascertaining an objective rating for each of the samples using an evaluation of the entirety of individual performed pair comparisons of samples by a mathematical model.

7. The method according to claim 6, wherein the mathematical model is a probabilistic model including a Bradley-Terry-Luce (BTL) model.

8. The method according to claim 6, wherein the rating of a sample results from the probability of sample preferences from all pair comparisons in all comparison requests.

9. The method according to claim 6, further comprising, after the ratings of the samples have been ascertained:
creating a rating model for objectively rating a sensory sample, including:
defining the rating as an output variable,
annotating the samples with the respective rating of the sample that results from a probability of sample preferences from all pair comparisons in all comparison requests, and
optimizing the rating model by training with the annotated samples.

10. A method for objectively rating a sensory sample, comprising the following steps:
providing a sensory sample; and
rating the sensory sample with a rating model, the rating model being created by:
generating comparison pairs and distributing them to individual comparison requests for experiment participants for subjective individual ratings of pair comparisons, including the following steps:
providing a data set including sensory samples;
identifying potentially promising comparison samples for each sample based on a metric, wherein the metric is based on a relationship between a possible estimation of a rating by experiment participants and at least one quantitative characteristic of the sample;
distributing a predetermined number of overall comparisons to the potentially promising comparison pairs, according to the following conditions:
each sample is equally often provided in a pair comparison, and
each sample is equally often provided as a response option A and a response option B in the pair comparisons;
generating the comparison requests for experiment participants by assigning the comparison pairs to the comparison requests, taking into account the following conditions to the effect that
each sample is not provided more frequently than once in a comparison request, and
each sample is equally often provided for predetermined subgroups of the entirety of all experiment participants;
after the comparison requests have been performed:
ascertaining an objective rating for each of the samples using an evaluation of the entirety of individual performed pair comparisons of samples by a mathematical model;
creating a rating model for objectively rating a sensory sample, including:
defining the rating as an output variable,
annotating the samples with the respective rating of the sample that results from a probability of sample preferences from all pair comparisons in all comparison requests, and
optimizing the rating model by training with the annotated samples.

11. The method according to claim 10, further comprising:
obtaining the sensory sample from a test object;
generating a rating of the sensor sample;
controlling at least one parameter of the test object that affects the sample; and
repeating the obtaining, generating, and controlling steps until the rating reaches a target value.

12. A computer system configured to generate comparison pairs and distributing them to individual comparison requests for experiment participants for subjective individual ratings of pair comparisons, the computer system configured to:
provide a data set including sensory samples;
identify potentially promising comparison samples for each sample based on a metric, wherein the metric is based on a relationship between a possible estimation of a rating by experiment participants and at least one quantitative characteristic of the sample;
distribute a predetermined number of overall comparisons to the potentially promising comparison pairs, according to the following conditions:
each sample is equally often provided in a pair comparison, and
each sample is equally often provided as a response option A and a response option B in the pair comparisons;
generate the comparison requests for experiment participants by assigning the comparison pairs to the comparison requests, taking into account the following conditions to the effect that
each sample is not provided more frequently than once in a comparison request, and
each sample is equally often provided for predetermined subgroups of the entirety of all experiment participants.

13. The computer system according to claim 12, comprising a sensor system for sensing the sample and/or an output device for outputting a rating of the sample.

14. A non-transitory computer-readable medium on which is stored a computer program for generating comparison pairs and distributing them to individual comparison requests for experiment participants for subjective individual ratings of pair comparisons, the computer program, when executed by a computer, causing the computer to perform the following steps:
providing a data set including sensory samples;
identifying potentially promising comparison samples for each sample based on a metric, wherein the metric is based on a relationship between a possible estimation of a rating by experiment participants and at least one quantitative characteristic of the sample;
distributing a predetermined number of overall comparisons to the potentially promising comparison pairs, according to the following conditions:
each sample is equally often provided in a pair comparison, and
each sample is equally often provided as a response option A and a response option B in the pair comparisons;
generating the comparison requests for experiment participants by assigning the comparison pairs to the comparison requests, taking into account the following conditions to the effect that:
each sample is not provided more frequently than once in a comparison request, and
each sample is equally often provided for predetermined subgroups of the entirety of all experiment participants.
